(19) United States
(12) Patent Application Publication
(10) Pub. No.: US 2008/0085098 A1
(43) Pub. Date: Apr. 10, 2008

(54) Method Of And System For Synchronizing Playback Of Audio/Video Signals

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,910

(22) PCT Filed: Oct. 10, 2005
(86) PCT No.: PCT/IB05/53313

§ 371 Date: Apr. 9, 2007

(30) Foreign Application Priority Data
Oct. 13, 2004 (EP) 04105030.3

(51) Int. Cl. H04N 9/475

(52) U.S. Cl. 386/75; 386/E05.052

(57) ABSTRACT

A method and system for the synchronization of the playback of AN data (AVD), in which the playback of the AN data (AVD) takes place using at least one synchronization signal (t) wirelessly received at time intervals (i), at least one portable transmitter device (1) which can be allocated to a user (B).

The invention relates to a method for the synchronization of the playback of audio/video data.

The invention further relates to a playback system with at least two playback devices for the playback of audio/video data.

The invention further relates to a portable transmitter device for a playback system for the playback of audio/video data.

The invention also relates to a playback device for the playback of audio/video data.

Furthermore, the invention relates to a computer program for the playback of audio/video data.

The invention also relates to a computer program product with a computer program for the playback of audio/video data.

A method of the type specified in the first paragraph and a system of the type specified in the second paragraph are known from patent document US 2002/0067909. With the known method or the known system respectively, audio/video data as well as relevant time information are stored by a stationary server for a playback of the audio/video data. Below, audio/video data are designated as “A/V data” for reasons of easier readability. For the playback of the A/V data stored on the server, playback devices are provided, which playback devices are combined into groups. The A/V data are transmitted by the server to all playback devices of the group, where these data are stored, after receipt of a request sent to the server by one playback device of a group. Here, the data transmission between the server and the playback devices takes place by means of a bidirectional radio transmitter connection. After each playback device has confirmed the receipt of the A/V data to the server, the server transmits a start signal to the playback devices, which playback devices then start the playback of the A/V data after receipt of the start signal. In order to ensure a synchronous playback of the A/V data for a longer period, additional information is transmitted by the server to the playback devices, which additional information indicates specific positions in the A/V data, starting from which positions the playback by the individual playback devices should take place.

With the known method or the known playback system respectively, however, it has proven to be a disadvantage that a bidirectional communication link is needed over the entire transmission section between the server and the playback devices, which is why the playback devices should have one transmitting/receiving arrangement each, which transmitting/receiving arrangement supports a signal transmission over the entire network to the server reliably and without an indeterministic delay. Thus, a multi-channel radio network is necessary for the realization of the known method or the known playback system respectively, which network involves very high manufacturing costs. Furthermore, the known method is also unsuitable for executing the playback of the A/V data on spatially distributed playback devices in such a manner that it appears synchronous for a moving user.

It is an object of the invention, to provide a method of the type indicated in the first paragraph, a playback system of the type indicated in the second paragraph, a transmitter device of the type indicated in the third paragraph, a playback device of the type indicated in the fourth paragraph and a computer program of the type indicated in the fifth paragraph as well as a computer program product of the type indicated in the sixth paragraph, with which aforesaid disadvantages are avoided.

In order to achieve aforesaid object, a method in accordance with the invention has characteristics in accordance with the invention, so that a method in accordance with the invention can be characterized in the way indicated below, namely:

Method for the synchronization of the playback of A/V data, in which the playback of the A/V data takes place using at least one synchronization signal wirelessly received at time intervals from at least one portable transmitter device, which can be allocated to a user.

In order to achieve the aforesaid object, characteristics in accordance with the invention are provided in a playback system in accordance with the invention, so that a playback system in accordance with the invention can be characterized in the way indicated below, namely:

Playback system for the execution of the method as claimed in any one of the claims 1 to 7, in which the playback system has at least two playback devices for the playback of A/V data and at least one mobile transmitter device, which mobile transmitter device is arranged for generating and transmitting a synchronization signal to the playback devices at time intervals, which playback devices are arranged for the purpose of wirelessly receiving the synchronization signals and to play back the A/V data using the synchronization signal.

In order to achieve the aforesaid object, characteristics in accordance with the invention are provided in a transmitter device in accordance with the invention, so that a transmitter device in accordance with the invention can be characterized in the way indicated below.

Mobile transmitter device for a playback system as claimed in any one of the claims 8 to 15.

In order to achieve the aforesaid object, characteristics in accordance with the invention are provided in a playback device in accordance with the invention, so that a playback device in accordance with the invention can be characterized in the way indicated below.

Playback device for A/V data for a playback system as claimed in any one of the claims 8 to 15.

In order to achieve the aforesaid object, characteristics in accordance with the invention are provided in a computer program in accordance with the invention, so that a computer program in accordance with the invention can be characterized in the way indicated. below.

Computer program with program code means for executing one or more steps of the method as claimed in any one of the claims 1 to 7, if the computer program is run in a playback device as claimed in claim 17.

In order to achieve the aforesaid object, characteristics in accordance with the invention are provided in a computer program product in accordance with the invention, so that a computer program product in accordance with the invention can be characterized in the way indicated below.

Computer program product with a computer program as claimed in claim 18, in which the computer program is stored on a computer readable data carrier.

By providing the characteristics in accordance with the invention, the advantage is obtained that the synchronization of the playback of A/V data on the various playback devices can take place in a very simple way, because only a unidirectional connection between the playback devices and the portable transmitter device is necessary for the synchronization of the playback.

In accordance with the measures of claim 2 or claim 9 respectively, the advantage is obtained that the influence of delays on the playback of the A/V data, which may arise from transmitting the A/V data to be played back to the playback devices, can be eliminated.

In accordance with the measures of claim 3 or claim 10 respectively, the advantage is obtained that the synchronous playback of the A/V data is easily ensured also over a longer period in a simple way.

However, it has proved particularly advantageous, when the measures of claim 4 or claim 11 respectively, are provided. Thereby, the advantage is obtained that with the availability of several transmitter devices, conflicts with the control or synchronization of the playback respectively, are avoided.

In accordance with the measures of claim 5 or claim 12 respectively, the advantage is obtained that with the synchronization of the playback, delay differences of acoustically played back audio signals can also be canceled.

In accordance with the measures of claim 6 or claim 13 respectively, the advantage is obtained that an instantaneous distance from a playback device to the transmitter device can be determined in a very simple way.

In accordance with the measures of claim 7 or claim 14 respectively, the advantage is obtained that the synchronization signal should contain only very little information, in which only a small transmission bandwidth is necessary between the transmitting device and the playback devices.

In accordance with the measures of claim 15, the advantage is obtained that a control of the type of playback is possible in a very simple and comfortable way for a user.

These and other aspects of the invention are apparent from and will be elucidated with reference to the embodiments described hereinafter, though the invention should not be considered limited to them.

In the drawings:

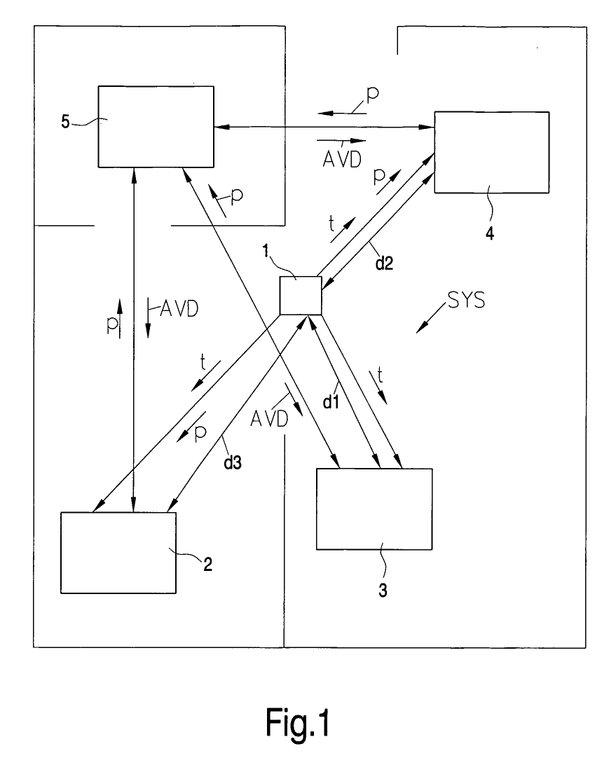

FIG. 1 shows a playback system in accordance with the invention for the playback of A/V data in the form of a block diagram.

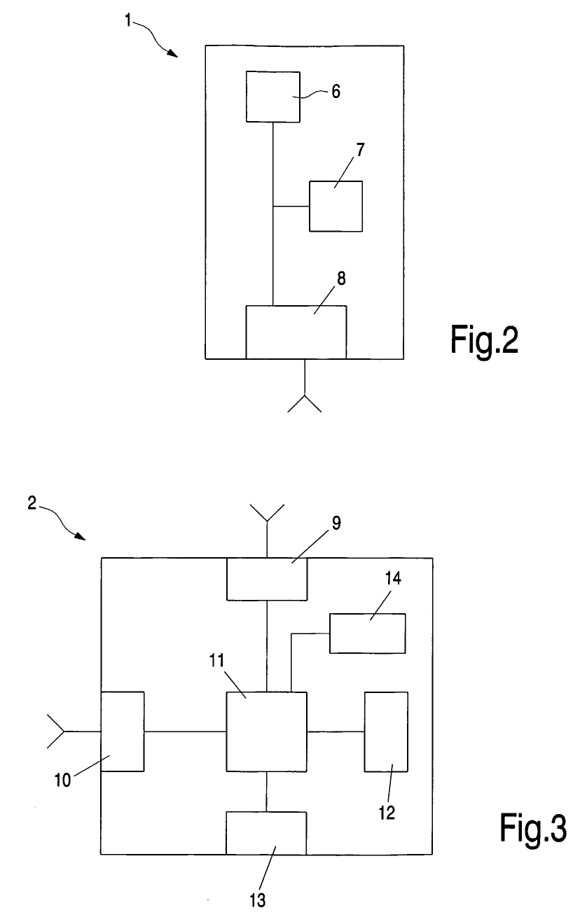

FIG. 2 shows a transmitter device in accordance with the invention for the playback system in accordance with FIG. 1, in the form of a block diagram.

FIG. 3 shows a playback device in accordance with the invention for the playback of A/V data for the playback system, in accordance with FIG. 1, in the form of a block diagram.

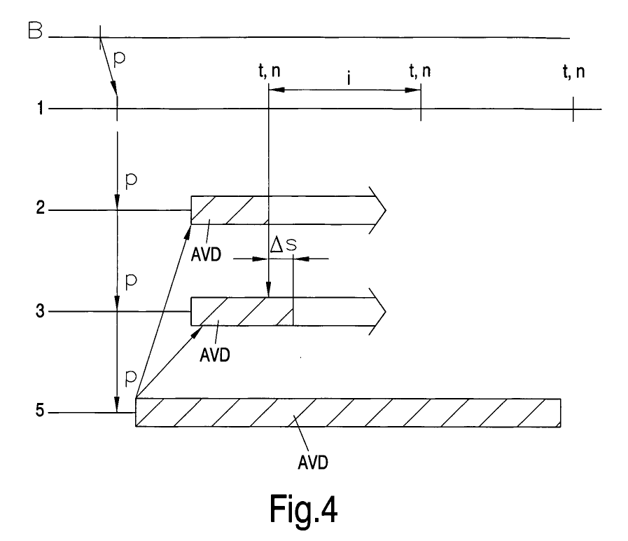

FIG. 4 shows a method in accordance with the invention for the synchronization of the playback of A/V data in the form of a flow chart.

FIG. 1 shows a playback system SYS in accordance with the invention for the playback of A/V data AVD. The playback system SYS has several playback devices 2, 3, 4, for example, computer with boxes connected to it for the playback of A/V data AVD.

In the present case, the playback devices 2, 3, 4 are, as is schematically represented in the Figure, in individual areas of a dwelling or a house and are connected to a server 5 over a data link. In the present case, the data link between the server 5 and the playback devices 2, 3, 4 is an Ethernet connection. It is observed that the connection can be realized by means of glass fiber connections or can be wireless, for example, over a Wireless Fidelity connection (WI-FI). A/V data AVD, which are stored on the server 5, can be transmitted by the server to the playback devices 2, 3, 4 via the data link, the transmission of the A/V data AVD in a variant of the invention taking place in accordance with the TCP/IP protocol. Alternatively, however, different transmission protocols can also be used instead of the TCP/IP protocol.

Further, a portable, user-allocated mobile transmitter device 1 is provided, which has a clock 6, in accordance with the embodiment represented in FIG. 2, a processor 7 and radio transmission means 8 for the transmission of signals to the playback devices 2, 3, 4. In the present case, the radio transmission means 8 are provided and designed for wireless transmission of signals to the playback devices 2, 3, 4 or to the server 5 respectively, on the basis of what is called “ZigBee” technology and the underlying standard IEEE 802.15.4. It may be observed that for wireless transmission of such signals another technology, for example, W-LAN (according to IEEE 802.11 standard) or Bluetooth (according to IEEE 802.15.1 standard) can also be used.

The transmitter device 1 further has an internal power supply, not represented here, for example, a rechargeable battery.

The processor 7 is configured by means of a computer program to generate a synchronization signal t using time signals of the clock 6 and to transmit it to the playback devices 2, 3, 4 by means of the radio transmission means 8. It is provided that the transmitter device 1 in an operating condition of the playback system SYS is worn on the body by a user. The transmitter device 1 preferably has a form that allows it to be worn behind an ear of the user.

The synchronization signal t is present in accordance with a preferred variant of the invention, in the form of digital synchronization messages generated at time intervals. Here, the synchronization signal t corresponds to a series of synchronization messages generated by the transmitter device 1 at different times, which synchronization messages contain time information about the proper time of the transmitter device 1.

Further, the synchronization signal t or the synchronization messages respectively may also contain instructions for the playback devices 2, 3, 4, to play back specific data blocks of the A/V data AVD immediately after receipt or after a defined time space after receipt of the synchronization signal t or the relevant synchronization message respectively.

In accordance with a further variant of the invention the synchronization signal t can also be present in the form of a periodically generated clock pulse, whereas the synchronization signal t need not contain explicit time information in this case, and the clock pulse can also be present in analog form.

Further, the transmission of the synchronization signal t to the playback devices 2, 3, 4 takes place at periodic time intervals in a preferred variant of the invention. An advantage of the transmission of the synchronization signal t to the playback devices 2, 3, 4 at periodic time intervals is that time information sent along can be very short, because successive time information items differ only in some bits and therefore only the transmission of these bits is absolutely necessary. A further advantage of the transmission of the synchronization signal t to the playback devices 2, 3, 4 at periodic time intervals comprises that with a corresponding large selection of the time intervals, the power consumption of the transmitter device 1 can be substantially reduced.

It is particularly advantageous, if there is a dynamic selection of the time intervals. In the case of no playback activity of the playback system SYS or no relevant change of location of the transmitter device 1 respectively, the transmission of synchronization signals t takes place at large time intervals, in the case of a user activity—for example, an input of control commands or operating commands respectively into the transmitter device 1—or a change of location, the transmission of the synchronization message t takes place at short time intervals. This guarantees a sufficiently precise locating of the mobile transmitter device 1 with minimum power consumption. A user activity is immediately detected by the mobile transmitter device 1, when it is used as a remote control. Whether the transmitter device 1 moves or whether it is in a stationary condition is detected by means of an acceleration sensor of the transmitter device 1.

As an alternative to the embodiments mentioned above, the length of the time interval designated as “i” in FIG. 4 between the sending of two successive clock pulses or synchronization messages respectively of the synchronization signal t, may also be determined in a randomly controlled way. The latter embodiment is advantageous in that an operation of the playback system SYS is possible without any problem when a plurality of active transmitter devices 1 are present with respect to a collision of the synchronization signals t generated by the individual transmitter devices 1.

Further, in a preferred variant of the invention the transmitter device 1 has a module, not shown here for reasons of representation, for input of control commands for the control of the playback of the A/V data AVD on the individual playback devices 2, 3, 4. The control commands are converted into control signals by the processor 7 and transmitted over the radio transmission means 8 to the playback devices 2, 3, 4, which playback devices 2, 3, 4 then execute the type of playback, for example, with reference to the volume, corresponding with the transmitted control commands.

In the examples of embodiment of the invention shown in FIG. 1 and FIG. 4, the A/V data AVD to be played back are stored on the server 5, and, as soon as a start signal p released by a user over the transmitter device 1 is transmitted to the server 5 for playback of the A/V data AVD, it is sent to the playback devices 2, 3, 4.

In the embodiment shown in FIG. 1 the transmission of the start signal p to the server takes place via the playback devices 2, 3, 4. For this purpose the start signal p is transmitted by the transmitter device 1 via radio to the playback devices 2, 3, 4. Depending on the position of the mobile transmitter device 1 with respect to the playback devices 2, 3, 4 or else by explicit selection of one or several playback devices 2, 3, 4, after receipt of the start signal p these devices transmit this signal p to the server 5, which server 5 thereupon starts the transmission of the A/V data AVD stored on it to the playback devices 2, 3, 4.

As an alternative to the transmission of the start signal p to the server 5 via the playback devices 2, 3, 4, the start signal p can also be directly transmitted to the server 5 by the transmitter device 1, which server 5, just like the playback devices 2, 3, 4, includes radio reception means, which are designated as 9 in FIG. 3, for receiving the start signal p from the transmitter device 1.

An alternative to the storage of the A/V data AVD on the server 5 and the transmission of the A/V data AVD to the playback devices 2, 3, 4 by the server 5 after receipt of the start signal p is that the A/V data AVD are stored in a permanent memory in each playback device 2, 3, 4. The advantage of this variant is that for the playback of the A/V data AVD, no transmission of the A/V data AVD from the server 5 to the playback devices 2, 3, 4 needs to take place after receipt of the start signal p, which is why in this embodiment of the invention the playback of the A/V data AVD can be started immediately after receipt of the start signal p by the playback devices 2, 3, 4.

In order to ensure a synchronous playback of the A/V data AVD on the individual playback devices 2, 3, 4, the playback devices 2, 3, 4 are arranged for the purpose of executing the playback of the A/V data AVD on the basis of the synchronization signal t received from the transmitter device 1, as described in detail further below.

The playback device represented in FIG. 3 is referred to as 2, while the other playback devices 3 and 4 represented in FIG. 1, are structured similarly in principle.

The playback device 2 comprises a radio receiving device 9 for receiving the synchronization signals t. Furthermore, a receiving unit 10 is provided with the server 5 designated as 5 in FIG. 1, for receiving A/V data AVD to be played back.

Further, the playback device 2 has a processor 11 and a memory 12 for the A/V data AVD as well as an output unit 13 for the A/V data AVD, for example, a display or a loudspeaker respectively.

The processor 11 is configured by means of a computer program in accordance with the invention for the purpose of controlling the playback of the A/V data AVD via the output unit 13 using the synchronization signal t. Further, the control of the playback of the A/V data AVD is described separately in the text below.

For the installation of the computer program in accordance with the invention on a playback device 2, 3, 4, the computer program can be stored on a computer-readable data carrier, for example, a CD-ROM, and transmitted via a corresponding reading unit of the playback device 2, 3, 4 to a memory of the playback device 2, 3, 4.

Since it is not always absolutely necessary for the A/V data AVD to be played back simultaneously on all playback devices 2, 3, 4 of the playback system SYS represented in FIG. 1, the playback devices 2, 3, 4 have measuring means 14 for measuring an instantaneous position of the transmitter device 1 relative to the playback devices 2, 3, 4. The measuring means 14 for determining the instantaneous position of the transmitter device 1 are designed as measuring devices for detecting a current field strength of a signal transmitted by the transmitter device 1, and can be implemented, for example, as a conventional wattmeter or as a standing wave measuring device. The field strength of the signal received from the transmitter device 1 and determined by the playback devices, are transmitted to the server 5, which server 5 derives a field strength sample of the field strengths and allocates this field strength sample to a current spatial position of the transmitter device 1.

In a preferred variant of the invention, the field strength of the synchronization signal t is measured by the measuring means 14, because generating a signal of its own by the transmitter device 1 and provided only for the measurement of the field strength, can be avoided.

It should be observed that for determining the position of the transmitter device 1 other methods can be used, for example, by means of a triangulation based on determined time differences of received signals. Such a triangulation method and system are known, for example, from the patent document WO 2004/036243 “WIRELESS LOCAL AREA NETWORK (WLAN) CHANNEL RADIO-FREQUENCY IDENTIFICATION (RFID) TAG SYSTEM AND METHOD THEREFOR”, whose disclosure in this connection is regarded as being incorporated here.

Depending on their instantaneous position relative to the transmitter device 1, each playback device 2, 3, 4 can decide whether or not it plays back the A/V data AVD, as positions of the transmitter device 1 or spatial competence areas are allocated to each playback device 2, 3, 4 within the playback system SYS. If the transmitter device 1 is located at a position allocated to a playback device 2, 3, 4 or in one of the areas allocated to a playback device 2, 3, 4 respectively, the associated playback device 2, 3, 4 takes part in the playback of the A/V data AVD.

To decide whether a playback device 2, 3, 4 plays back the A/V data AVD due to its instantaneous position relative to the transmitter device 1, the processor 11 is correspondingly configured by means of a computer program.

If a user moves away from the spatial competence area of a first playback device 2, 3, 4 and moves into the spatial competence area of a second playback device 2, 3, 4, there will be a hand off procedure for the playback of the A/V data AVD from the first playback device 2, 3, 4 to the second playback device 2, 3, 4. In the following explanation of this hand off procedure the reference symbol 2 is selected for the first playback device taking part in the hand off procedure and the reference symbol 3 is selected for the second playback device taking part in the hand off procedure in order to simplify the legibility of the text. The hand off procedure for the playback of the A/V data AVD from the first playback device 2 to the second playback device 3 takes place in two phases. In the first phase, if the user or the transmitter device 1 respectively, moves away from the sole competence area of the first playback device 2 into an overlapping area of the competence areas of both playback devices 2, 3, a playback operating condition of the second playback device 3 is activated, so that both playback devices 2, 3 are active simultaneously. If both playback devices 2 and 3 are shifted to an active playback operating state, the playback of the A/V data AVD is synchronized by means of the synchronization signal t of the processors 11 of the playback devices 2, 3. In the second phase, if the user is located in the sole competence area of the second playback device 3, the playback of the A/V data AVD on the first playback device 2 is terminated by its processor 11. Here, the processor 11 of the first playback device 2 checks whether the transmitter device 1 is within the competence area of the first playback device 2 by means of the current field strength sample and a field strength sample specifying the competence area of the first playback device 2 and stored in a memory of the first playback device 2. If the comparison of the current field strength sample with the stored field strength sample does not result in a match, then the playback is terminated.

Each of the processors 11 of the two playback devices 2, 3 is configured to execute the hand off procedure by means of a suitable computer program.

As an alternative to the control of the hand off procedure by the processors 11 of the individual playback devices 2, 3, the control of the hand off procedure can also take place by the server 5. For this purpose, corresponding control commands are transmitted by the server 5 to the playback devices 2, 3, 4 taking part in the hand off procedure.

If the playback devices 2, 3, 4 recognize that the user moves between the competence areas of two or several playback devices 2, 3, 4 on account of the instantaneous changes of the position of the transmitter device 1, then these playback devices 2, 3, 4, in accordance with a preferred variant of the invention, are kept active or in a ready condition respectively, so that the playback devices 2, 3, 4 are kept in an operating condition, in which they can play back the A/V data AVD at any time.

The user can teach the playback system SYS an intelligent behavior for the control of the playback of the A/V data AVD, in that he defines specific playback parameters for different positions, such as, for example, the volume or parameters for the playback of basses etcetera. For defining these playback parameters depending on the position, the user with the transmitter device 1 goes to an arbitrary position in the reception range of the playback devices 2, 3, 4 and enters the corresponding values for the playback parameters via an input arrangement, for example a keyboard or a button for volume control, provided for entering the playback parameters. The playback parameters are then transmitted to the server 5, where the entered values of the playback parameters and the associated detected position of the transmitter device 1 are stored by means of the measuring equipment 14 of the playback devices 2, 3, 4. The playback system SYS has its own operating condition for recording the values of the playback parameters depending on the instantaneous position of the transmitter device 1, where this operating condition is activated by an input of a corresponding command. The input of this command can take place, for example, by pressing a switch provided particularly for this purpose or a button of the transmitter device 1 respectively. The competence areas of the individual playback devices 2, 3, 4 are determined in a similar way.

The recorded values of the playback parameters and the associated positions of the corresponding transmitter device 1 are allocated, in accordance with a preferred variant of the invention, by means of an identification message n for identifying the transmitter device 1 and generated by it and transmitted to the server 5. In this way, a “playback profile” can be defined for different users or transmitter devices 1 respectively. With this variant of the invention, priorities are defined for the individual playback profiles or transmitter devices 1 respectively, so that no conflicts arise with the playback of the A/V data AVD, if several transmitter devices 1 are active simultaneously in the playback system SYS. By means of the identification message n the transmitter device 1 can also be allocated unambiguously to a specific user, while different authorizations can also be determined for users with the playback of the A/V data AVD in the playback system SYS. For example, a user can be entitled to retrieve all video data or video films stored in the playback system SYS for them to be played back, whereas another user can only view selected video signals or films respectively.

In accordance with a preferred variant of the invention, delay differences of acoustic waves from the individual playback devices 2, 3, 4 taking part in the playback of the A/V data AVD to the user and designated as As in FIG. 4 are canceled. Canceling the delay differences As is particularly expedient for overlapping zones of areas of responsibility, in which the simultaneous playback takes place via two or several playback devices 2, 3, 4. Determining the optimal delay correction for a specific overlapping area takes place in that the user goes with the activated transmitter device 1 into the overlapping area, while always two of the playback devices 2, 3, 4 emit a test signal. The user can now vary the delay difference As between the playback devices 2, 3, 4 by entering corresponding control commands in the transmitter device 1, which are transmitted in the form of control signals to the playback devices 2, 3, 4, in such a manner that the reverberation felt by him is minimized. The setting of the delay difference As selected by the user is then stored for example, on the server 5 by the playback system SYS and reproduced with the renewed stay of the transmitter device 1 in this area.

In the simplest variant of the invention, a synchronous condition of the playback of the A/V data AVD is reached by synchronizing the clocks of the playback devices 2, 3, 4 by means of the synchronization signals t. In that case, the transmitter device 1 takes over the function of a time master for the playback devices 2, 3, 4. It is advantageous, when the A/V data AVD are then permanently stored in the playback devices 2, 3, 4, as in this case no transmission of the A/V data AVD is necessary from the server 5 to the playback devices 2, 3, 4, so that, on the one hand, the indeterministic delays during transmission of the A/V data AVD to the playback devices 2, 3, 4, can be avoided and, on the other hand, a simpler structure of the playback system SYS can be obtained.

Triggered by the synchronization signal t, the playback of the A/V data AVD then takes place simultaneously on the playback devices 2, 3, 4 involved. In this embodiment of the invention, provided that the playback speeds of the A/V data AVD on the individual playback devices 2, 3, 4 are identical, a synchronization of the playback can be obtained in very simple way. However, the equality of the playback speeds can be ensured very simply, as the clocks of all the playback devices 2, 3, 4 are synchronized with each other by means of the synchronization signal t.

An alternative variant of the invention provides that if the synchronization signal t contains no explicit time information and is present in the form of periodic clock pulses, the playback of the A/V data AVD is also started by the start signal p and begins with a predefined clock pulse of the synchronization signal t, which predefined clock pulse follows the start signal p. For example, the playback can begin, for example, with the second clock pulse of the synchronization signal t, which second clock pulse follows the start signal p. With the embodiment of the invention described in this paragraph the interval i between two clock pulses is detected in the playback devices 2, 3, 4 and the number of clock pulses of the synchronization signal t since receipt of the start signal p is counted. In this way it is possible to obtain a common global time base common to all the playback devices 2, 3, 4 also without explicit time information in the synchronization signal t by means of which time base the synchronization of the playback of the A/V data AVD can be executed. The synchronization with the clock pulses can take place similarly to the method described below, in connection with a further variant of the invention, with the aid of time information contained in the A/V data AVD.

A further variant of the invention provides that the A/V data AVD are transmitted from the server 5 to the playback devices 2, 3, 4 in the form of data streams, for example, as an “Advanced Streaming Format”, ASF for short, and buffered there in a buffer memory, for example, in a time period of 1-2 seconds. The ASF enables the storage and transmission of synchronized multimedia data. Existing A/V data AVD can be synchronized and jointly data-reduced, so that different data rates can be selected. An ASF file comprises a header object, a data object and an index object, the header object describing the contents of the file and the data object containing the individual A/V data AVD in the form of ASF data units. Each ASF data unit then contains the data for a specific time segment.

The index object contains the time information of the individual ASF data units. For obtaining a synchronous playback of the A/V data AVD in the playback devices 2, 3, 4, the received clock pulses t are compared after the start of the playback (step III in FIG. 4) with time information contained in the A/V data AVD, for example, the time information contained in the index object mentioned above. So, the synchronization signal t can, as has already been mentioned above, contain as information the proper time of the clock 6 of the transmitter device 1, while with the start signal p an internal timing which is relevant to the playback of the A/V data AVD is started in the playback devices 2, 3, 4. In this way, the time elapsed since the receipt of the start signal p can be determined and compared with the internal time information contained in the A/V data AVD. An internal time information signal for a data block, contained in the A/V data AVD, can read, for example: “this data block should be started 5 seconds after the start of the playback and should be terminated 20 seconds after the start of the playback”. With the synchronization signal t, it can now be checked in a simple way; whether the internal time information contained in the A/V data AVD coincides with the time scale predefined by the synchronization signal t, and which is the same for all the playback devices 2, 3, 4. As a result of this comparison, which is executed in the playback devices 2, 3, 4 taking part in the playback of the A/V data AVD, a deviation of the actual play moment from the target play moment is determined. Depending on the result of the comparison, a correction of the playback is carried out in the individual playback devices 2, 3, 4. The comparison mentioned just now and also the correction of the playback is executed independently in each of the playback devices 2, 3, 4 taking part in the playback of the A/V data AVD. The method for the synchronization described in this paragraph can also be executed very simply with a synchronization signal t, which synchronization signal t is present only in the form of clock pulses and contains no explicit time information, as for a synchronous playback of the A/V data AVD on the playback devices 2, 3, 4 merely the time period elapsed since the beginning of the playback should be determined.

If several transmitter devices 1 are present or active in the playback system SYS, for example, because several users simultaneously use the playback system SYS, it is advantageous as already mentioned above, for each of the transmitter devices 1 to transmit an identification message n to the server 5 or to the playback devices 2, 3, 4 by means of which message each of the transmitter devices 1 is clearly identifiable. The right to synchronize the playback of A/V data AVD can be allocated to the individual transmitter devices 1 in a hierarchical way. Thus it can be provided that the synchronization of the playback of the A/V data AVD is executed with a first transmitter device 1, whereas, however, if a second transmitter device is activated and an identification message n from this transmitter device is received by the server 5 or by the playback devices 2, 3, 4, the synchronization of the playback takes place with the synchronization signal t of the second transmitter device.

FIG. 4 shows a method for the synchronization of the playback of the A/V data AVD in the playback system SYS. With the method described below, the A/V data AVD are stored on the server 5 before the playback is started.

In a first step, a user B enters a start command via the transmitter device 1. The transmitter device 1 sends the start signal p after input of the start command to the playback devices 2, 3 (step I). The playback device 3 transmits the start signal p to the server 5, and in the present case the playback device 3 and the server 5 exchange data representing such a start signal p over an Ethernet connection. As an alternative to the transmission of the start signal p to the server 5 via the spatially nearest playback device 2, 3, 4 the start signal p, as already mentioned above, can be transmitted directly from the transmitter device 1 to the server 5. After receipt of the start signal p, the server S transmits the A/V data AVD, which are to be played back, to the playback devices 2, 3. The playback devices 2, 3 buffer the received A/V data AVD each over a predefined period, for example, for 1-2 seconds (step II). The playback of the A/V data AVD in the individual playback devices 2, 3 is released by the synchronization signal t. The start of the playback of the A/V data AVD takes place here substantially in synchronism with the receipt of the synchronization signal t by the respective playback device 2, 3, thus immediately after receiving the synchronization signal t. However, the playback of the A/V data AVD in the example of embodiment shown does not begin until after the receipt of the second clock pulse or the second synchronization message of the synchronization signal t (step III). In principle, the synchronization signal t is generated at periodic time intervals i and transmitted to the playback devices 2, 3 or received by them respectively. The time intervals I, however, may also have a random length as has already been mentioned above.

In addition, together with the synchronization signal t, the identification message n can be transmitted by the transmitter device 1 for the identification of the transmitter device 1, if in the playback system more than one transmitter device 1, allocated a one user B, is provided. Also, further control pulses can be transmitted by the transmitter device 1 to the playback devices 2, 3, 4, if the transmitter device is arranged as a remote control for the playback devices 2, 3, 4 and is operated as such.

1. A method for the synchronization of the playback of A/V data (AVD), in which the playback of the A/V data (AVD) takes place using at least one synchronization signal (t) wirelessly received at time intervals (i) from at least one portable transmitter device (1), which can be allocated to a user (B).

2. A method as claimed in claim 1, in which the A/V data (AVD) are buffered before playback.

3. A method as claimed in claim 1, in which the playback of the A/V data (AVD) takes place based on a comparison of the received synchronization signal (t) with time information contained in the A/V data (AVD).

4. A method as claimed in claim 1, in which at least one identification message (n) transmitted by the portable transmitter device (1) is received and the playback of the A/V data (AVD) takes place additionally based on the at least one identification message (n).

5. A method as claimed in claim 1, in which the playback of the A/V data (AVD) takes place additionally depending on the instantaneous position of the mobile transmitter device (1) relative to at least one playback device (2, 3, 4).

6. A method as claimed in claim 5, in which the instantaneous position of the mobile transmitter device (1) is determined relative to the at least one playback device (2, 3, 4) based on a field strength measured in the playback device (2, 3, 4) of at least one signal sent by the transmitter device (1).

7. A method as claimed in claim 1, in which the synchronization signal (t) is received at periodic time intervals.

8. A playback system (SYS) for implementing the method as claimed in claim 1, in which the playback system (SYS) has at least two playback devices (2, 3, 4) for the playback of A/V data (AVD) and one mobile transmitter device (1), which mobile transmitter device is arranged (1) for generating a synchronization signal (t) and transmitting it at time intervals (i) to the playback devices (2, 3, 4), which playback devices (2, 3, 4) are arranged for receiving the synchronization signals (t) wirelessly and playing back the A/V data (AVD) while using the synchronization signal (t).

9. A playback system (SYS) as claimed in claim 8, in which the playback devices (2, 3, 4) are arranged for buffering the A/V data (AVD) to be played back.

10. A playback system (SYS) as claimed in claim 8, in which the playback devices are arranged for performing the playback of the A/V data (AVD) based on a comparison of the synchronization signal (t) with time information contained in the A/V data (AVD).

11. A playback system (SYS) as claimed in claim 8, in which the at least one mobile transmitter device (1) is arranged for transmitting for its identification at least one identification message (n) to the playback devices (2, 3, 4) and the playback devices (2, 3, 4) are arranged for performing the playback of the A/V data (AVD) based on the identification message (n) and synchronization signal (t) received from the transmitter device (1).

12. A playback system (SYS) as claimed in claim 8, in which the playback devices (2, 3, 4) are arranged for detecting an instantaneous position of the mobile transmitter device (1) relative to the playback devices (2, 3, 4) and for performing the playback of the A/V data (AVD) depending on the synchronization signal (t) and the instantaneous position of the mobile transmitter device (1) relative to the playback devices (2, 3, 4).

13. A playback system (SYS) as claimed in claim 12, with which each of the playback devices (2, 3, 4) is arranged for the purpose of determining the instantaneous position of the mobile transmitter device (1) relative to the playback devices (2, 3, 4) based on the field strength of at least one signal sent by the mobile transmitter device (1).

14. A playback system (SYS) as claimed in claim 8, with which the mobile transmitter device (1) is arranged for transmitting the synchronization signal (t) to the playback devices (2, 3, 4) at periodic time intervals.

15. A playback system (SYS) as claimed in claim 8, in which the mobile transmitter device (1) is arranged as a remote control for the playback devices (2, 3, 4).

16. A mobile transmitter device (1) for a playback system (SYS) as claimed in claim 8.

17. A playback device (2, 3, 4) for A/V data (AVD) for a playback system (SYS) as claimed in claim 8.

18. A computer program with program code means, for executing a method for the synchronization of the playback of A/V data (AVD, in which the playback of the A/V data (AVD) takes place using at least one synchronization signal (t) wirelessly received at time intervals (i) from at least one portable transmitter device (1), which can be allocated to a user (B) if the computer program is executed in a playback device (2, 3, 4) as claimed in claim 17.

19. A computer program product with a computer program as claimed in claim 18, in which the computer program is stored on a computer-readable data carrier.
